(19) United States
(12) Patent Application Publication
(10) Pub. No.: US 2020/0321172 A1
(43) Pub. Date: Oct. 8, 2020

(54) DISCONNECTOR

(71) Applicant: BREMAS ERSCE S.P.A., Cambiago (IT)

(72) Inventor: Andrea MATTARELLI, Verona (IT)

(21) Appl. No.: 16/303,922

(22) PCT Filed: May 19, 2017
(86) PCT No.: PCT/EP2017/062117

§ 371 Date: Nov. 21, 2018

(30) Foreign Application Priority Data
May 23, 2016 (IT) 102016000052422

(51) Int. Cl. H01H 19/64; H01H 19/08; H01H 19/04

(52) U.S. Cl. CPC H01H 19/64; H01H 19/04; H01H 19/08

(57) ABSTRACT

A disconnector that includes at least two modular contact boxes, each one having a box-like body coupled to a contiguous box-like body of a contiguous modular contact box. Each box-like body defines a seat that accommodates a moving contact and two peripheral seats, each of which accommodates a corresponding fixed contact that can be accessed from outside the modular contact box. The at least two box-like bodies include at least one first box-like body, in which at least the outward-facing surface has a first finish, and at least one second box-like body, in which at least the outward-facing surface has a second finish, the contacts of the first box-like body or bodies having one polarity and the fixed contacts of the second box-like body or bodies having an opposite polarity.

### TECHNICAL FIELD

The present disclosure relates to a disconnector, particularly for direct-current applications.

### BACKGROUND

In many applications, and in general in the sector of devices for electrical plants, the use is known of disconnectors, and, among these, of rotary switches.

Conventional disconnectors are generally constituted by one or more modular contact boxes, each one generally comprising a moving contact, and in general able to rotate, and a pair of fixed contacts. The rotation of the rotary contact, which, if two or more modular contact boxes are coupled, occurs simultaneously for each module, and makes it possible to interrupt or allow the flow of current between the two fixed contacts of each module.

Such disconnectors are used both in DC circuits and, in some cases, in alternating current circuits.

A problem common to many conventional disconnectors is the difficulty of connecting electrical cables of different polarities to the fixed contacts of the disconnector.

Such problem is particularly felt in applications in which the disconnectors are accommodated in areas that are difficult to access or inside poorly-lit electrical switchboards.

Examples are disconnectors associated with photovoltaic plants, or inserted in electrical switchboards located in service spaces such as command switchboards for lifts.

In fact, especially with regard to the above mentioned applications, it is found that inside the same switchboard there is a considerable number of electrical components, and also of disconnectors, which need to be connected, respectively, to electrical cables of different polarities.

### SUMMARY

The aim of the present disclosure is to provide a disconnector, particularly for direct-current applications, that eliminates the drawbacks and overcomes the limitations of the known art, by being contained in size and rapid to assemble, and in which the connection to electrical cables is extremely practical and facilitated.

Within this aim, the disclosure relates to providing a disconnector that is capable of offering the widest guarantees of reliability and safety in use.

The disclosure relates to providing a disconnector that is easy to implement and economically competitive when compared to the known art.

This aim and these and other advantages which will become better apparent hereinafter are achieved by providing a disconnector, particularly for direct-current applications, according to claim 1.

### BRIEF DESCRIPTION OF THE DRAWINGS

Further characteristics and advantages of the disclosure will become better apparent from the description of some preferred, but not exclusive, embodiments of a disconnector, particularly for direct-current applications, according to the disclosure, which are illustrated by way of non-limiting example with the aid of the accompanying drawings wherein:

FIG. 1 is a perspective view of a disconnector with a first arrangement of the modular contact boxes;

FIG. 2 is a side view of the disconnector of FIG. 1;

FIG. 3 is another perspective view of a disconnector with a second arrangement of the modular contact boxes;

FIG. 4 is a side view of the disconnector shown in FIG. 3; and

FIG. 5 is a perspective view of a practical example of a modular contact box.

### DETAILED DESCRIPTION OF THE DRAWINGS

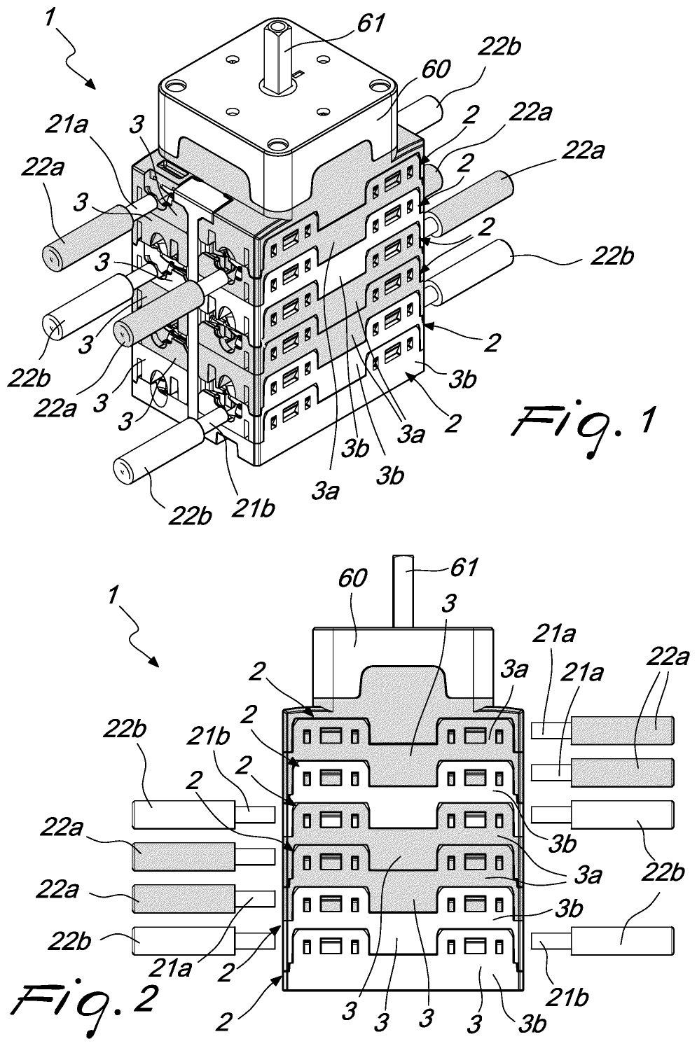

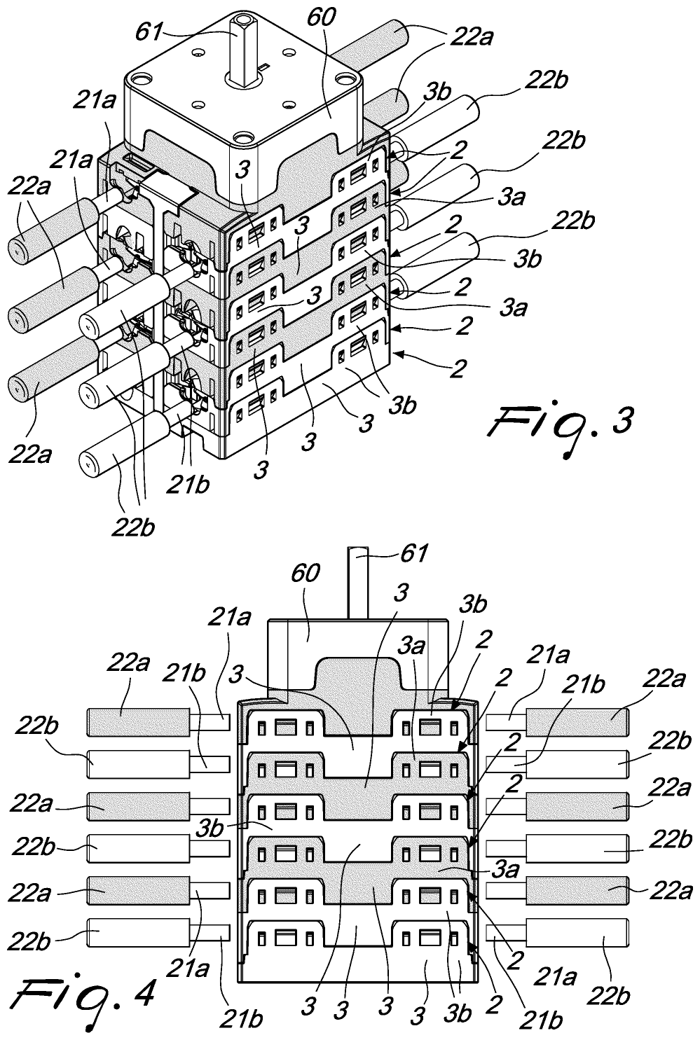

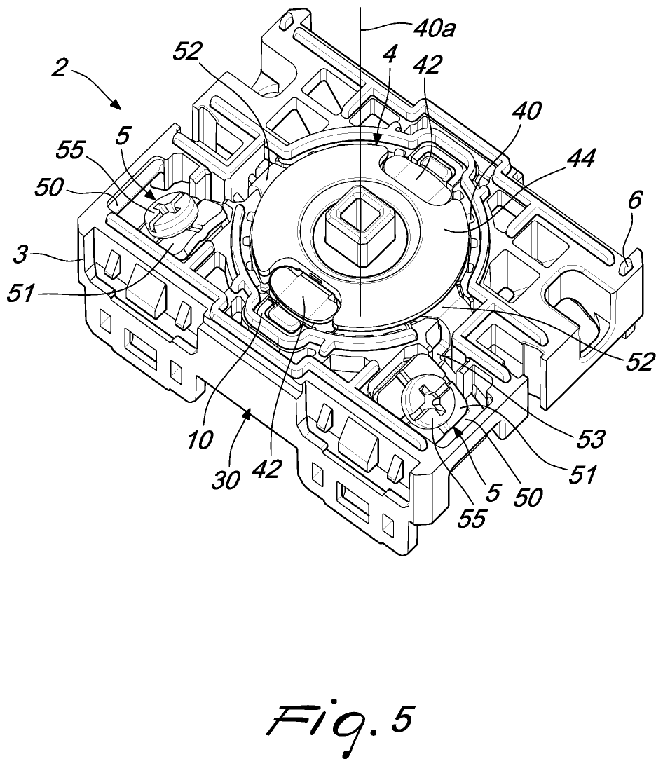

With reference to FIGS. 1-5, the disconnector generally designated by the reference numeral 1 comprises at least two modular contact boxes 2, each one comprising a box-like body 3 coupled to a contiguous box-like body 3 of a contiguous modular contact box 2.

The box-like body 3 defines a seat 40 that accommodates a moving contact 4 and two peripheral seats 50, each of which accommodates a corresponding fixed contact 5 that can be accessed from outside the modular contact box 2.

According to the present disclosure, the above mentioned at least two box-like bodies 3 comprise at least one first box-like body 3a, in which at least the outward-facing surface has a first finish, and at least one second box-like body 3b, in which at least the outward-facing surface has a second finish.

In particular, the contacts of the first box-like body 3a have one polarity while the contacts of the second box-like body 3b have the opposite polarity to that of the contacts of the first box-like body 3a.

According to a preferred embodiment, the outward-facing surface of the first box-like body 3a and of the second box-like body 3b is respectively of a first color and of a second color: in particular, the first color is different from the second color.

It has been found to be particularly advantageous to have the first box-like body and the second box-like body 3a, 3b be molded in plastic with respective first and second pigments of different colors.

Preferably, the disconnector 1 according to the disclosure comprises a disconnector for DC applications.

For example, the disconnector 1 comprises a disconnector for photovoltaic applications.

Conveniently, the seat 40 accommodates a moving contact 4, which can rotate about the axis 40a of the seat 40 relative to the box-like body 3, in order to engage with the fixed contacts 5 that are arranged with a connecting portion 51 thereof in the peripheral seats 50, or in order to disengage from the fixed contacts 5.

It is possible for the disconnector 1 to have a “snap-fitting” box, which comprises a box-like structure 60 that accommodates an actuation shaft 61 that is connected kinematically to the moving contacts 4.

The actuation shaft 61 is kinematically connected to the moving contacts 4 accommodated in the box-like bodies 3 by way of interposition of an elastic loading device accommodated inside the box-like structure 60.

The rotation of the actuation shaft 61 causes the simultaneous rotation of the moving contacts 4.

Advantageously, the box-like body 3 in plan view has a substantially rectangular shape structure.

By way of example, the figures show disconnectors 1 that comprise six modular contact boxes 2, mutually stacked on top of each other.

Conveniently, each fixed contact 5 comprises a connecting portion 51, a contact portion 52, and a connecting portion 53 that extends between the connecting portion 51 and the contact portion 52.

The connecting portion 51 can be accessed from outside the modular contact box 2, and from outside the disconnector 1 proper.

The connecting portion 51 in fact can comprise a screw tightening system 55, where the screw is operable by way of a screwdriver, in order to tighten it onto an external electrical cable 21a, 21b.

As is known, the external electrical cables 21a, 21b have different colored sheaths according to their polarity (for example the color red for positive polarity and the color black for negative polarity).

Preferably, the color of the first box-like body 3a substantially corresponds to the color of the sheath 22a of an external electrical cable 21a to be connected, of the corresponding polarity, and the color of the second box-like body 3b substantially corresponds to the color of the sheath 22b of an external electrical cable 21b to be connected, of the corresponding polarity.

Advantageously, the color of the first box-like body 3a, if it is associated for example with fixed contacts of positive polarity, will substantially correspond to the color of the sheath of the external electrical cable 21a of positive polarity, and the color of the second box-like body 3b, being associated with fixed contacts of the opposite polarity, and therefore negative, will substantially correspond to the color of the sheath 22b of the external electrical cable 21b of negative polarity.

The moving contact 4 comprises a metal conducting portion which defines two end portions 42 that are adapted to come into contact with the contact portions 52 of the fixed contact 5, according to their position.

The metal conductor portion 41 advantageously comprises two conducting plates.

Operation of the disconnector is clear and evident from the foregoing description.

In practice it has been found that the disconnector according to the present disclosure achieves the intended aims and advantages because the disconnector may be easily assembled, even in conditions where the area where the disconnector is accommodated is difficult to access owing to limited space or to poor lighting.

In fact, providing the outer surfaces of the box-like bodies 3 with different finishes and/or colors according to the polarities of the respective contacts 4 makes it possible to facilitate identification of the type of electrical cables to be connected to each modular contact box 2.

Another advantage of the disconnector according to the disclosure relates to the fact that the connection portions of the fixed contacts are distributed, in the disconnector, so that the different electrical polarities are easily distinguishable.

Another advantage of the disclosure relates to the fact that it can also be used in various applications, both direct current and alternating current.

The disconnector, particularly for direct-current applications, thus conceived is susceptible of numerous modifications and variations all of which are within the scope of the appended claims.

Moreover, all the details may be substituted by other, technically equivalent elements.

In practice the materials employed, provided they are compatible with the specific use, and the contingent dimensions and shapes, may be any according to requirements.

The disclosures in Italian Patent Application No. 102016000052422 (UA2016A003666) from which this application claims priority are incorporated herein by reference.

1-6. (canceled)

7. A disconnector comprising at least two modular contact boxes, each of the modular contact boxes comprising a box-like body coupled to a contiguous box-like body of a contiguous modular contact box, each box-like body defining a seat that accommodates a moving contact and two peripheral seats, each of which accommodates a corresponding fixed contact that can be accessed from outside said modular contact box, wherein said at least two box-like bodies comprise at least one first box-like body, in which at least the outward-facing surface has a first finish, and at least one second box-like body, in which at least the outward-facing surface has a second finish, the contacts of said first box-like body having one polarity and the fixed contacts of said second box-like body having an opposite polarity.

8. The disconnector according to claim 7, wherein said disconnector is a disconnector for direct-current applications.

9. The disconnector according to claim 7, wherein each one of said peripheral seats accommodates a connecting portion of a corresponding fixed contact that can be accessed from outside said modular contact box, said moving contact being able to rotate about the axis of said seat with respect to said box-like body in order to engage the fixed contacts arranged with their connecting portion in said peripheral seats or in order to disengage from said fixed contacts.

10. The disconnector according to claim 7, wherein at least an outward-facing surface of said first box-like body and of said second box-like body is respectively of a first color and of a second color, said first color being different from said second color.

11. The disconnector according to claim 7, wherein said first box-like body and second box-like body are molded in plastic with respective first and second pigments of different colors.

12. The disconnector according to claim 7, wherein a color of said first box-like body substantially corresponds to a color of a sheath of an external electrical cable to be connected, of the corresponding polarity, and wherein the color of said second box-like body substantially corresponds to a color of a sheath of an external electrical cable to be connected, of the corresponding polarity.
